(19) United States
(12) Patent Application Publication
(10) Pub. No.: US 2011/0067043 A1
(43) Pub. Date: Mar. 17, 2011

(54) SYSTEM AND METHOD FOR PROVIDING ADVERTISING-ON-DEMAND

(75) Inventors: CHUN HSU, Tu-Cheng (TW); YUAN-CHANG TSOU, Tu-Cheng (TW); DENG-RUNG LIU, Tu-Cheng (TW)

(73) Assignee: HON HAI PRECISION INDUSTRY CO., LTD., Tu-Cheng (TW)

(21) Appl. No.: 12/646,905

(22) Filed: Dec. 23, 2009

(30) Foreign Application Priority Data
Sep. 15, 2009 (CN) 200910307025.5

(51) Int. Cl. H04H 60/33; H04N 7/025

(52) U.S. Cl. 725/9; 725/32; 725/120; 725/131

(57) ABSTRACT

A TV advertisement server (TA server) and method of providing advertising-on-demand includes a TV, a set-top-box (STB) connected with the TV, and connected with the STB. When the STB sends a request to download a TA list, the TA server sends the TA list to the STB for a user selecting one or more desired TV advertisements. The TA server may generate a new TA list according to the selection and acquire the selected TV advertisements from a storage device. The acquired TV advertisements may be transmitted to the STB and broadcasted on the TV.

### BACKGROUND

1. Technical Field

Embodiments of the present disclosure generally relate to a television connected with a set-top-box (STB), and more particularly to a system and method providing advertising-on-demand

2. Description of Related Art

Advertisements are commonly designed to sell goods and publicize events. On television (TV), different kinds of advertisements appeal to different demographic groups. However, conventional TV channels cannot deliver dedicated categories of TV advertisements to viewers.

What is needed, therefore, is a system and method for providing advertising-on-demand, to overcome the limitations described.

### BRIEF DESCRIPTION OF THE DRAWINGS

FIG. 1 is a block diagram of one embodiment of a system of providing advertising-on-demand

FIG. 2 is a flowchart illustrating one embodiment of a method for advertising-on-demand

FIG. 3 is a schematic diagram of one embodiment of an operating interface for the system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the data “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

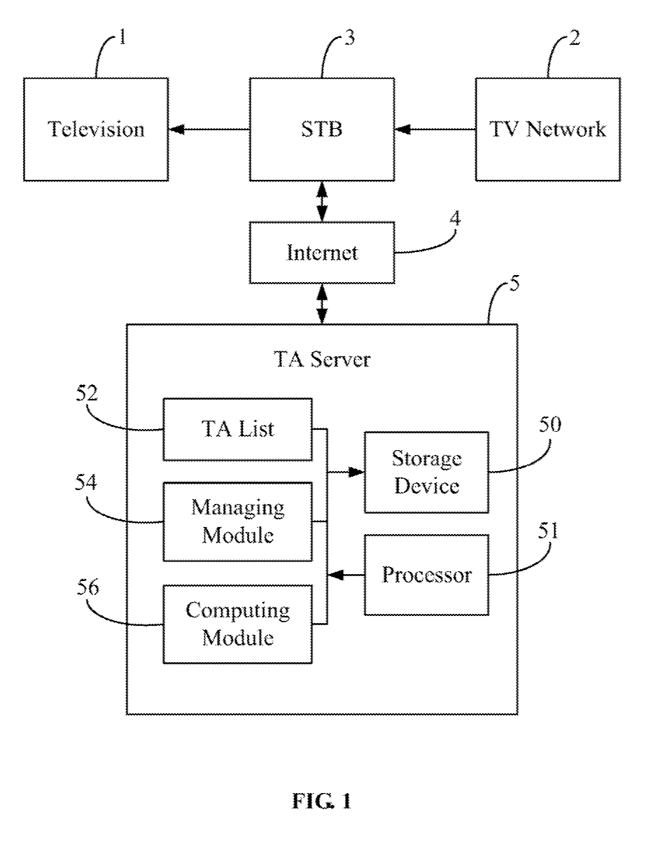

FIG. 1 is a block diagram of one embodiment of a system providing advertising-on-demand The system includes a television (TV) 1, a TV network 2, a set-top-box (STB) 3, and a TV advertisement server (TA server) 5. The TV 1 is connected with the STB 3. The STB 3 is connected with the TV network 2, and configured for receiving TV signals from the TV network 2. In the embodiment, the STB 3 is further connected with the TA server 5 via a network, such as the Internet 4. The STB 3 is further operable to select desired TV advertisements from the TA server 5, and broadcast the selected TV advertisements on the TV 1.

In the embodiment, the TA server 5 includes a storage device 50, at least one processor 51, a TA list 52, a management module 54, and a computation module 56. The storage device 50 is configured to store TV advertisements and the TA list 52. The storage device 50 may further store software instructions for the management module 54 and the computation module 56 that are executed by the at least one processor 51 of the TA server 5. Each of the TV advertisements has a serial number, as set by the management module 54. In the embodiment, the management module 54 further sets a serial number for each of TV channels in the TV 1. The TA list 52 stores serial numbers of TV channels and serial numbers of the TV advertisements of each of the TV channels. If any TV advertisement is deleted from the storage device 50, or a new TV advertisement is added to the storage device 50, the management module 54 updates the TA list 52.

In the embodiment, the management module 54 is operable to send the TA list to the STB 3 in response to a download request from the STB 3 to download the TA list 52, and generate a new TA list by selecting one or more desired TV advertisements from the TA list 52. The new TA list includes serial numbers of the selected TV advertisements and serial numbers of corresponding TV channels of the desired TV advertisements. The management module 54 is further operable to acquire the TV advertisements from the storage device 50, and transmit the acquired TV advertisements to the STB 3. The STB 3 broadcasts the acquired TV advertisements on the TV 1.

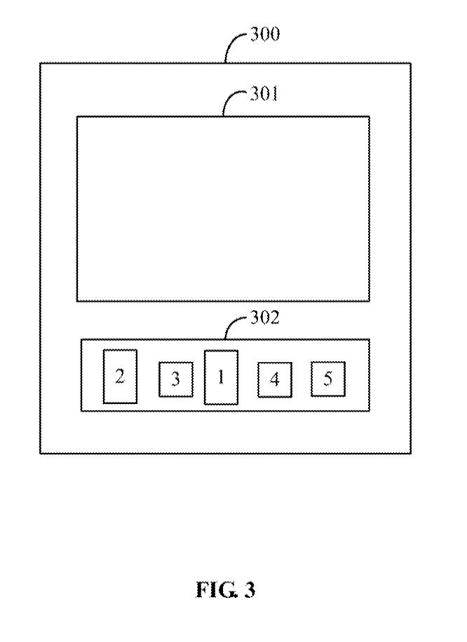

As shown in FIG. 3, the TV 1 provides an operating interface 300 for advertising-on-demand. The operating interface 300 includes a main display interface 301 and a TA list display interface 302. The main display interface 301 is used for displaying contents of one TV channel. The TA list display interface 302 is operable to display the TA list 52 from which selection is made of desired TA advertisements. After selection of one or more TV advertisements from the TA list display interface 302, such as a serial number “1” and a serial number “2” are selected from the TA list 52, a new TA list including the serial numbers “1” and “2” is generated. The TA server 5 acquires the selected TV advertisements from the storage device 50 according to the new TA list, and transmits the acquired TV advertisements to the STB 3. The STB 3 broadcasts the acquired TV advertisements on the main display interface 301.

In the embodiment, the computation module 56 is operable to calculate a total number of viewings of each of the TV advertisements, to compute an audience rating for each of the TV advertisements.

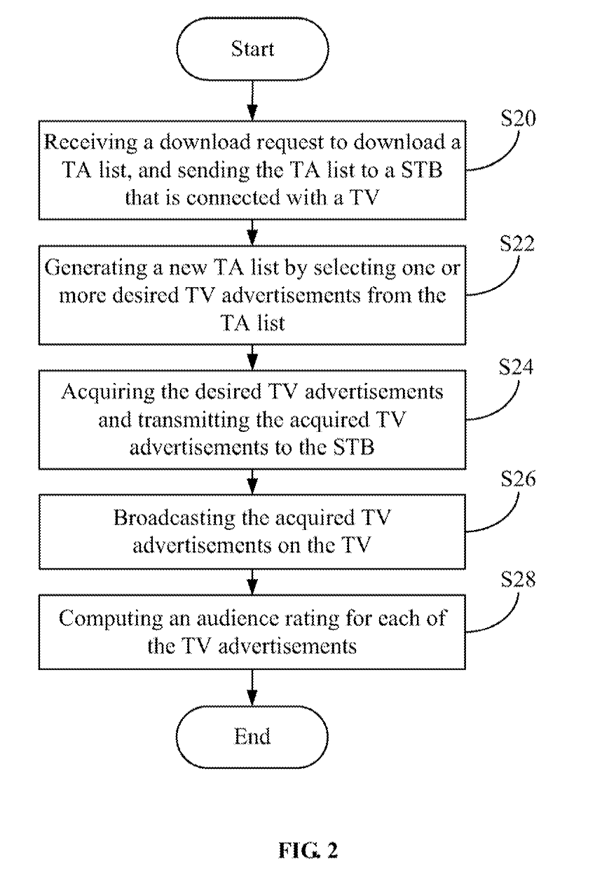

FIG. 2 is a flowchart illustrating one embodiment of a method for advertising-on-demand of a TV 1 connected with a STB 3. Depending on the embodiment, additional blocks in the flow of FIG. 2 may be added, others removed, and the ordering of the blocks may be changed.

In block S20, the management module 54 receives a download request from the STB 3 to download a TA list, and sends the TA list 52 to the STB 3. The TA list 52 includes serial numbers of TV channels of the TV 1 and serial numbers of TV advertisements of each of the TV channels.

In block S22, after one or more desired TV advertisements are selected from the TA list 52, the management module 54 generates a new TA list. The new TA list includes serial numbers of the desired TV advertisements and serial numbers of corresponding TV channels of the desired TV advertisements.

In block S24, the management module 54 acquires the desired TV advertisements from the storage device 50 and transmits the acquired TV advertisements to the STB 3.

In block S26, the STB 3 broadcasts the acquired TV advertisements on the TV 1.

In block S28, the computation module 56 calculates a total number of viewings of each of the TV advertisements, and computes an audience rating for each of the TV advertisements.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method for providing advertising-on-demand utilizing a set-top-box (STB) connected with a TV advertisement (TA) server, the method comprising:
receiving a download request from the STB to download a TA list;
sending the TA list to the STB, the TA list comprising serial numbers of TV channels of the TV and serial numbers of TV advertisements of each of the TV channels;
generating a new TA list by selecting one or more desired TV advertisements from the TA list, the new TA list comprising serial numbers of the desired TV advertisements and serial numbers of corresponding TV channels of the desired TV advertisements;
acquiring the desired TV advertisements from a storage device of the TA server; and
transmitting the acquired TV advertisements to the STB which broadcasts the acquired TV advertisements on the TV.

2. The method as described in claim 1, further comprising setting a serial number for each of the TV advertisements and setting a serial number for each of the TV channels.

3. The method as described in claim 1, further comprising:
updating the TA list upon a condition that any of the TV advertisements is deleted from the storage device; or
updating the TA list upon a condition that a new TV advertisement is added to the storage device.

4. The method as described in claim 1, further comprising:
calculating a total number of viewings of each of the TV advertisements; and
computing an audience rating for each of the TV advertisements.

5. A storage medium having stored thereon instructions that, when executed by a processor of a television advertisement (TA) server, cause the TA server to perform a method of providing advertising-on-demand, the method comprising:
receiving a download request from a set-top-box (STB) to download a TA list;
sending the TA list to the STB, the TA list comprising serial numbers of TV channels of the TV and serial numbers of TV advertisements of each of the TV channels;
generating a new TA list by selecting one or more desired TV advertisements from the TA list, the new TA list comprising serial numbers of the desired TV advertisements and serial numbers of corresponding TV channels of the desired TV advertisements;
acquiring the desired TV advertisements from a storage device of the TA server; and
transmitting the acquired TV advertisements to the STB which broadcasts the acquired TV advertisements on the TV.

6. The storage medium as described in claim 5, wherein the method further comprises setting a serial number for each of the TV advertisements and setting a serial number for each of the TV channels.

7. The storage medium as described in claim 5, wherein the method further comprises:
updating the TA list upon a condition that any of the TV advertisements is deleted from the storage device; or
updating the TA list upon a condition that a new TV advertisement is added to the storage device.

8. The storage medium as described in claim 5, wherein the method further comprises:
calculating a total number of viewings of each of the TV advertisements; and
computing an audience rating for each of the TV advertisements.

9. A TV advertisement (TA) server for providing advertising-on-demand utilizing a set-top-box (STB) connected with the TA server, the TA server comprising:
a storage device operable to store TV advertisements and a TA list, each of the TV advertisements comprising a serial number, the TA list comprising serial numbers of TV channels of the TV and serial numbers of the TV advertisements of each of the TV channels; and
a management module operable to send the TA list to the STB in response to a download request to download the TA list, generate a new TA list by selecting one or more desired TV advertisements from the TA list, acquire the desired TV advertisements from the storage device, and transmit the acquired TV advertisements to the STB which broadcasts the acquired TV advertisements on the TV, wherein the new TA list comprises serial numbers of the desired TV advertisements and serial numbers of corresponding TV channels of the desired TV advertisements.

10. The TA server m as described in claim 9, wherein the management module is further operable to set a serial number for each of the TV advertisement and a serial number for each of the TV channels.

11. The TA server as described in claim 10, wherein the management module is further operable to update the TA list when any of the TV advertisements is deleted from the storage device, or a new TV advertisement is added to the storage device.

12. The TA server as described in claim 9, wherein the TA server further comprises a computation module operable to calculate a total number of viewings of each of the TV advertisements, and compute an audience rating for each of the TV advertisements.
